(19) United States
(12) Patent Application Publication
(10) Pub. No.: US 2007/0061779 A1
(43) Pub. Date: Mar. 15, 2007

(54) Method and System and Computer Program Product For Maintaining High Availability Of A Distributed Application Environment During An Update

(76) Inventors: Bernd Dowedeit, Holzgerlingen (DE); Thomas Graser, Leonberg (DE); Matthias Haeussler, Nattheim (DE); Juergen Schneider, Althengstett (DE)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(21) Appl. No.: 11/531,094

(22) Filed: Sep. 12, 2006

(30) Foreign Application Priority Data
Sep. 13, 2005 (DE) 05108362.4

(51) Int. Cl. G06F 9/44

(52) U.S. Cl. 717/120; 717/168

(57) ABSTRACT

A method and system and computer program product for updating Java libraries in a distributed application environment while maintaining its high availability is provided. In one embodiment, the distributed application environment comprises multiple computers having nodes connected with each other via a network, and application components are distributed over the multiple computer for exchanging objects in a serialized mode with each other, wherein each of said application component is running in a Java Runtime environment. The Java Runtime environment provides Java libraries being used by said application component at runtime, wherein update process comprises the steps of: stopping at least a single node within the distributed application environment, updating the Java libraries of the node, and re-starting the updated node while all remaining nodes of said distributed application environment are operational and continuously exchanging at least XML serialized objects with each others, and successively repeating for each node of said distributed application environment said aforementioned steps.

### BACKGROUND OF THE INVENTION

1. Field of the Invention

The present invention relates in general to method and system for maintaining the high availability of a distributed application environment during its update, and in particular to updates of Java libraries in a distributed application environment while concurrently maintaining its high availability.

2. Description of Background

A distributed application environment is a computer system with data and program components physically distributed across more than one computer. A distributed application environment consists of multiple autonomic computers (nodes) linked via a network infrastructure and that are equipped with software used for coordination. In a distributed application environment all nodes communicate with each other, coordinate each other and exchange messages with each other.

Various hardware and software architectures exist that are usually used for distributed application environment. At a lower level, it is necessary to interconnect multiple nodes with some sort of network, regardless of that network being printed onto a circuit board or made up of several loosely-coupled devices and cables. At a higher level, it is necessary to interconnect processes running on those nodes with some sort of communication system.

No matter, what kind of architecture is used a distributed application environment can be split into several vertical layers of the architecture. The bottom layer is the hardware which contains on the one hand the autonomic nodes of the environment and the physical network layer to connect these nodes. The middle layer is a software layer that contains the operating system and all required network software implementation in order to access the physical network architecture and make use of it. This middle layer also contains the so-called middleware software layer, which is defined as the software layer that lies between the operating system and the application components on each site of the system.

This means the middleware enables application components to exploit the possibilities of the distributed application environment to centrally provide high-level abstractions and services to applications, to ease application programming, application integration, and system management tasks. Over the years, middleware has evolved from its initial limited focus on the efficiency of transaction management to this bigger role.

The top layer is the application layer. All underlying layers enable a platform for applications that run on several nodes of a distributed application environment. This behavior enables benefits like scalability and high-availability.

Since a computer system or a network consists of many parts in which all parts usually need to be present in order for the whole to be operational, much planning for high availability centers around backup and failover processing and data storage and access. For storage, a redundant array of independent disks (RAID) is one approach. A more recent approach is the storage area network (SAN).

High-availability is one of the major constraint of a distributed application environment. In order to enable the highest possible availability rate redundant components for failover are required. Failover is the capability to switch over automatically to a redundant or standby computer server, system, or network upon the failure or abnormal termination of the previously active server, system, or network. Failover happens without human intervention and generally without warning, unlike switchover.

Systems designers usually provide failover capability in servers, systems or networks requiring continuous availability and a high degree of reliability.

Updates of application components in a distributed application environment normally require a synchronous shut-down of all nodes, replacing the old application components with the new ones, and restarting the distributed application environment system with the new software components. During update time the high availability of the distributed application environment is not given. One particular example can be provided to ease understanding.

Java 2 Platform, is a Java-based distributed application that runs in a variety of environments. This programming platform is often used for developing and running distributed multi-tier architecture applications, based largely on modular application components running on an application server. This means that all application components, e.g. Java libraries, are run within the Java Virtual Machine (JVM). All application components run within a JVM share the same libraries. In most cases several JVMs, which are required for several nodes of an environment, need to have the same libraries as well in order to enable the application components which are running within them to exchange objects and messages with each other. A library (or archive) is a collection of Java classes. These libraries can be referenced by Java applications running within the JVM.

In a distributed application environment it is the most-likely case that several application components make usage of a single library and the classes that are contained. If objects are exchanged between different nodes of a distributed application environment they need to be serialized at the sender node and de-serialized at the receiver node.

The binary Java object serialization is the de facto standard for serializing Java objects. In order to decode the serialized byte stream at the receiver node the class file at the encoding node (sender node) and the class file at the decoding node (receiver node) must be identical. This means that if the binary serialization is used for exchange of remote objects the class file at the sender and receiver node must be the same.

If a certain library has to be replaced for a certain reason (e.g. there is a newer version, patch or update required), all other nodes dealing with the object of a certain class must update the libraries synchronously to keep the system running. If there is a mismatch of class file or library version between two nodes an object exchange between them can cause a crash of the communication and the entire environment. This means that all JVMs using the library need to stop synchronously and restart using the new library. The consequence is that the availability of the entire distributed application environment is not given while updating of the libraries.

Consequently, it is desirable to provide a method and system that can address the problems of the prior art. It is desirous to provide updates of a distributed application environment while concurrently maintaining its high-availability.

### SUMMARY OF THE INVENTION

The shortcomings of the prior art are overcome and additional advantages are provided through a method and system and computer program product for updating Java libraries in a distributed application environment while maintaining its high availability. In one embodiment, the distributed application environment comprises multiple computers connected with each other via a network, and application components are distributed over the multiple computer for exchanging objects in a serialized mode with each other, wherein each of said application component is running in a Java Runtime environment. The Java Runtime environment provides Java libraries being used by said application component at runtime, wherein update process comprises the steps of: stopping at least a single node within the distributed application environment, updating the Java libraries of the node, and re-starting the updated node while all remaining nodes of said distributed application environment are operational and continuously exchanging at least XML serialized objects with each others, and successively repeating for each node of said distributed application environment said aforementioned steps.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows the layers of a distributed application environment as per one embodiment of the present invention;

FIG. 2A-2C show the basic update process as used by one embodiment of the present invention;

FIGS. 2D and 2E show the serialization/de-serialization process as used by one embodiment of the present invention;

FIGS. 3A and 3B show alternate embodiments of the present invention; and

FIGS. 3C and 3D show examples of implementation of the switching component as per one embodiment of the present invention.

### DESCRIPTION OF THE INVENTION

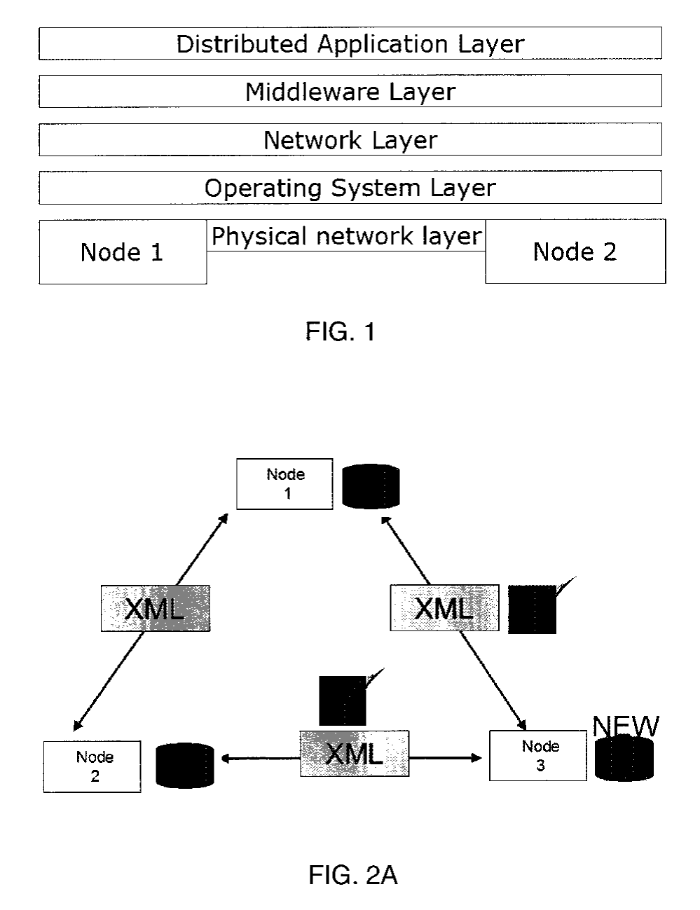

FIG. 1 provides an illustration of the layers of a distributed application environment as per one embodiment of the present invention. The discussions of the embodiments of the present invention as will be provided below can be better understood by referring to FIG. 1 when appropriate but a lengthy discussion of FIG. 1 is not necessary and will not be provided here.

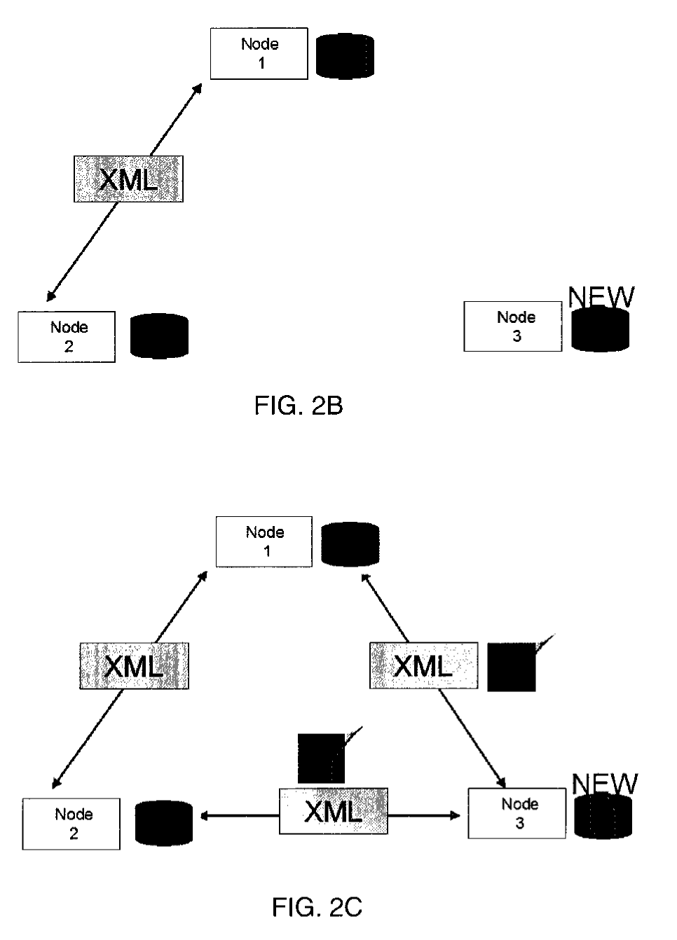

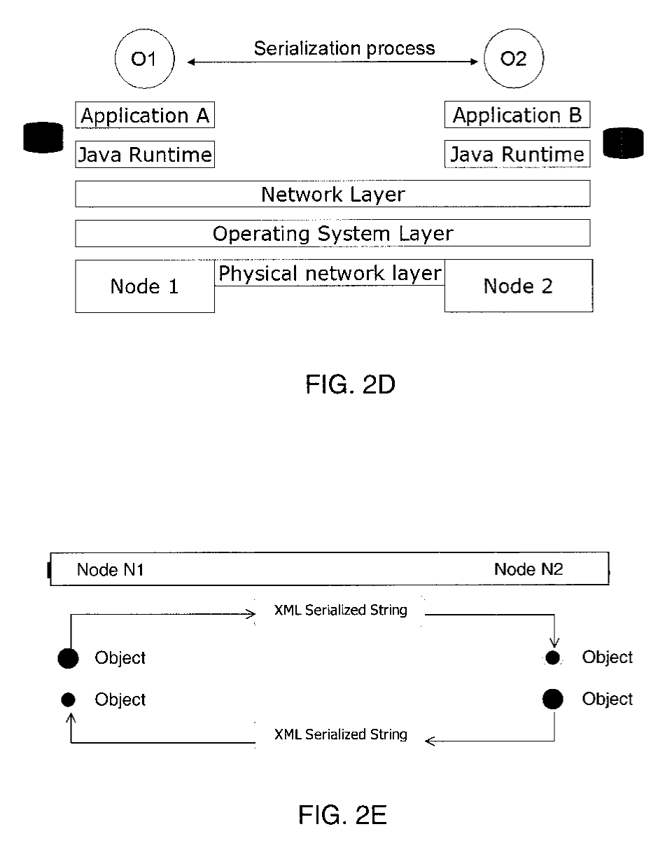

FIGS. 2A though 2C provide an update process according to one embodiment of the present invention FIG. 2A-2C, using a java based application environment. It should be noted that while in the discussions below, Java based applications are used, it is only as per example to further understanding and other applications and similar environments can be substituted under the workings of the present invention.

FIG. 2A-2C shows an example of a distributed application environment with three nodes N1-N3, each having the same Java library 4, and exchanging objects with each other. Now an update of the Java library 4 should be performed according to the present invention. First, Node N3 will be stopped while Node N2 and N3 still running and exchanging Java objects with each other (see FIG. 2B). The new library 4 is set and the Node N3 can be restarted.

Thereafter, the updated Node N3 is running again and can exchange Java objects with Nodes N1 and N2 using the older version of the library (see FIG. 2C). Exchanging Java objects in a distributed application environment during the update process according to the present invention requires serialization of Java objects in XML.

The binary Java object serialization depends not only on the objects but on the unique version ID of the Java class. If there is a mismatch the de-serialization process falls. Using XML Java object serialization the version ID of the Java class is not regarded. It only depends on the matching of package and class name. That means if the structure of the class vary from one class version to another one but the package and the class remain the same, the XML serialization engine will attempt to de-serialize the exchanged object. Additional members in the target class file are set to null while missing members in the target class file are discarded.

This functionality is provided by the XML serializing API and does not have to be implemented by the application code itself. For example, if there is an object holding two member variables at serialization and the class file on the deserialization node does only have one of the two member variables only this one will be set and the other one will not be regarded. In turn, if the incoming object does only have one member variable and the target class does expect two, only the matching one will be set and the other one initialized with null.

This behavior enables the toleration of mismatching class versions. Although only Node N3 is updated with a new version of the Java library at that point of time and N1 and N2 still using the older version of the Java library an exchange of objects between the Nodes N1 and N2 with N3 is possible without affecting a mismatch. The update process as described for Node N3 can be successively repeated with N1 or N2 without affecting a mismatch. In connection with FIG. 2D and 2E a more detailed description of the serialization/de-serialization process as used by the present invention is given.

FIG. 2D shows an example of a distributed application environment having Nodes N1-N2. Compared with the prior art a new Application Programming Interface (API) supporting XML serialization is provided to both Nodes N1-N2, especially as a part of the Java application components running in a Java Runtime Environment.

The procedure how a Java object is serialized/de-serialized according to the present invention is explained in more detail with respect to FIG. 2E. It is assumed that class file at Node N1 has more members variables than class file in Node N2. If the object is de-serialized at Node N2 only the members set in the transported objects are set. All others are set to null. It is assumed that class file in Node N2 has less member variables than class file in Node N1. If the object is de-serialized at Node N2 only the common members of the transported object and the class file in Node N2 are set. Other values are discarded.

Both described scenarios can be combined, e.g. that the class file in Node N2 has a member which class file of Node N1 does not have and vice versa. In summary all mismatch scenarios which are described above, the communication will not break down if there was an update on one Node of the entire distributed application environment.

The XML serialization according to the present can only be performed with Java classes implementing the JavaBean specification, e.g. every JavaBean class should implement java.io.Seralizable interface, it should have no parametric constructor, properties should be accessed using get and set methods etc.

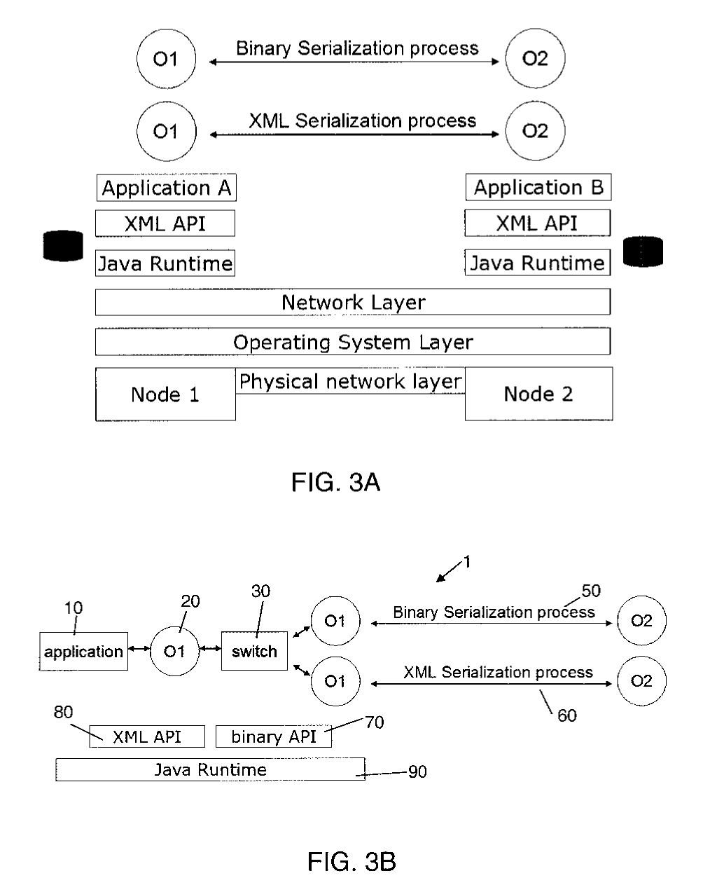

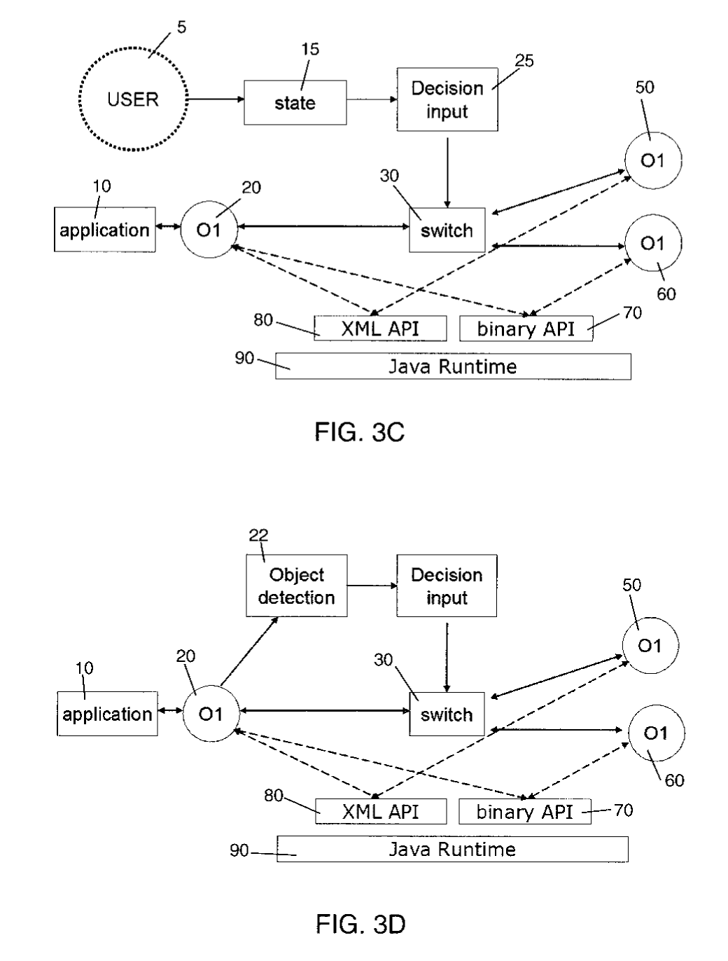

In conjunction with FIG. 3A further embodiments of the present invention are described. It is also assumed that the inventive embodiments are implemented in a Java-platform based distributed environment having a Java Runtime environment. The Java Runtime environment consists of a wide array of technologies, each of which provides a distinct portion of the overall development or runtime environment. For example, end-users typically interface with the Java virtual machine and the standard set of class libraries.

The heart of the Java platform is the concept of a common “virtual” processor that executes Java bytecode programs. This bytecode is the same no matter what hardware or operating system the program is running under. The Java platform provides an interpreter called the Java virtual machine (JVM), which translates the Java bytecode into native processor instructions at run-time. This permits the same application to be run on any platform that has a virtual machine available.

In most modern operating systems, a large body of reusable code is provided to simplify the programmers job. This code is typically provided as a set of dynamically loadable libraries that applications can call at runtime. Because the Java platform is not dependent on any specific operating system, applications cannot rely of any of the existing libraries. Instead, the Java platform provides a comprehensive set of standard class libraries, containing much of the same reusable functions commonly found in modern operating systems.

The Java class libraries serve three purposes within the Java platform. Like other standard code libraries, they provide the programmer a well-known set of functions to perform common tasks, such as maintaining lists of items or performing complex string parsing. In addition, the class libraries provide an abstract interface to tasks that would normally depend heavily on the hardware and operating system. Tasks such as network access and file access are often heavily dependent on the native capabilities of the platform. The Java java.net and java.io libraries implement the required native code internally, then provide a standard interface for the Java applications to perform those tasks. Finally, some underlying platforms may not support all of the features a Java application expects. In these cases, the class libraries can either emulate those features using whatever is available, or provide a consistent way to check for the presence of a specific feature.

As explained in conjunction with the FIG. 2A-2E the basic aspect of the present invention—if updating a distributed application environment—is to use XML serialization instead of binary serialization because XML serialization tolerates certain differences of the Java libraries. Despite the explained advantages of XML serialization in camparision with binary serialization there are disadvantages as well, e.g. XML serialization is restricted JavaBean classes, binary serialization does not create so much data in total and does not require an additional XML parser which consumes a certain amount of memory. However the restriction to JavaBean classes is even more important because it is very likely that not all serialized classes will be of the JavaBeans type.

With respect to above mentioned restrictions of the XML serialization a combination of both serialization types can bring the highest efficiency of serialization and still enable continuous operation and high availability of the distributed application environment. FIG. 3A shows the basic implementation for the combination of both serialization types. Additional to the standard Java Platform, a XML serialization API must be additionally provided.

The binary serialization API is already part of the currently provided Java Runtime. The application have access to both APIs, namely the binary and the XML serialization API. It depends on the application code which serialization method is used and how the various possibilities are exploited.

In one embodiment two variations of the combination of both types of serialization can be considered. First, alternating serialization uses the required type of serialization at a time only. Second, parallel serialization uses both types of serialization at the same time and the decision which one to be used is based on the type of the object to be serialized (e.g. JavaBean object or non-JavaBean object).

Alternating serialization only uses one type of serialization at a time and the decision which one to use has to be done by the user. Alternating serialization uses the binary serialization and their advantages during normal runtime of the distributed application environment. For the case that the distributed application environment requires an update, the user switches the serialization behaviour to XML serialization and an update can be fulfilled without the requirement to stop all nodes at the same time. This means that the application will be able to run and perform operations during the update procedure. The drawback of this solution is that exchange of non-JavaBean classes cannot be performed during the timeframe of the update.

Parallel serialization uses both types of serialization at the same time and the decision which one is to be used is based on the type of the object to be serialized. Parallel serialization combines the advantages of both types of serialization during the runtime of the application. For the case that the incoming object is not of JavaBean class the object will be serialized with the binary serialization method. If the object is of JavaBean class the object will be serialized with XML serialization (see FIG. 3D).

If there is an update process the nodes can be stopped one at a time. The update can be installed and the node can be restarted. The communication between the other nodes can continue. As the serialization does use XML and binary serialization all the time, updates of non-JavaBean classes are not possible. A version conflict between two classes on different nodes will inevitably cause a crash when the binary stream is deserialized.

Therefore this solution is only capable of updating JavaBean classes, because they will be serialized into an XML stream and version conflicts are tolerated. The advantage of this solution is to have both serialization paths operational all the time. The drawback is the restriction to the JavaBean class type, as described. If all types of classes are to be updated the alternating solution has to be used and during updates only XML will be tolerated. The drawback of this solution is that the classes that are updated can only be of JavaBean type, because if other classes are updated there might be serialization problems on the binary side during the time of the software update.

FIG. 3B shows the technical implementation requirements for combining both types of serialization in a distributed application environment. For the sake of simplicity it is shown the sender node 1 only. The receiver node will be identical.

The application 10 wants to send an object 20 to a remote node and the object 20 has to be serialized before. The application is based on the Java Runtime 90 and provides access to the XML 80 and the binary 70 serialization API. The new component which decides the type of serialization 50, 60 to be used is the switching component 30. The switching component 30 may be part of the application 10 or forms a separate component having an interface with the application 10. The decision logic of the switching component 30 can either be based on incoming object type (e.g. parallel serialization) or be user-driven (e.g. alternating serialization).

An implementation example of the switching component for alternating serialization is given in FIG. 3C. The switching component 30 is a part of the application 10 that has various input and various output components. Basically it can be said, that in any case the switching component 30 receives a Java object 20 as an input, then receives an input from a certain decision logic 25, and based on that input the incoming object will be serialized into a binary 50 or an XML 60 encoded stream.

The basic application 10 logic submits an object O1 20 as an input to the switching component 30. The switching component 30 makes a decision which type of serialization should be used. The decision is based on a state 15 which is set by the user 5. If the state 15 is set to “regular mode” all serialization is done via binary serialization 50. If the user 5 sets the state 15 to update mode this state will affect the decision input. From this point the switching component 30 will only use XML-serialization 60.

For the duration of the update only JavaBean objects can be serialized. This means that this state will also affect the entire application. The application will have to guarantee that only tolerated objects are exchanged during that state period. Possible solutions to handle this problem could be to 1) set the application into a mode where only JaveBeans are exchanged; and 2) put non-JavaBean objects into a queue. This means the objects are buffered, before they are serialized to avoid problems at de-serialization. After the application is reset to “regular mode” the queue can be released and all buffered objects are exchanged. In addition, after the update process is finished the state can be reset to “regular mode” and the application flow process in a normal alternating serialization way.

A further implementation example of the switching component for parallel serialization is given in FIG. 3D. The basic switching logic is absolutely the same as in the previous embodiment to FIG. 3C. The difference is the decision input for the switching component 30. In this case the decision is based on the type of the object 20. This means the basic application 10 submits an object 20 for transmission. The object detection mechanism 22 detects, if the object 20 is of JavaBean type or not. If the object is of that type the switch will use XML serialization 60, if not binary serialization 50 is used.

In this embodiment the state does not change when an update is performed. Due to the fact that the update affects only JavaBean classes no state is required. The nodes are simply stopped one at a time. When the updated nodes are restarted the parallel serialization can continue as before. The binary serialization would not cause a crash, because non-JavaBean classes are not affected. In other embodiment, of course, there is also the possibility of further combinations of the two approaches and can be treated similarly under the workings of the present invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for automatically updating Java libraries in a distributed application environment while maintaining its high availability, wherein said distributed application environment comprising multiple computers having one or more nodes connected with each other via a network, wherein application components are distributed over said multiple computer for exchanging objects in a serialized mode with each other, wherein each of said application component is running in a Java Runtime environment, wherein said Java Runtime environment provides Java libraries being used by said application component at runtime, wherein said update process comprises the steps of:
stopping at least a single node within said distributed application environment,
updating the Java libraries of said node, and
re-starting said updated node while all remaining nodes of said distributed application environment are operational and continuously exchanging at least XML serialized objects with each others, and
successively repeating for each node of said distributed application environment said aforementioned steps.

2. The method of claim 1, wherein said update of said libraries includes JavaBean classes and/or non-JavaBean classes.

3. The method of claim 1, wherein said objects are JavaBean objects only.

4. The method of claim 1 , wherein said objects are JavaBean and non-JavaBean objects.

5. The method of claim 2, wherein during said update process said JavaBeans objects are exchanged in a XML serialized mode only and said non-JavaBean objects are buffered as long as the update process is running, and when said update process is completed said JavaBean objects and said non-JavaBean objects are exchanged either in XML serialized mode or binary serialized mode.

6. The method of claim 4, wherein during said update process said JavaBeans objects are exchanged in a XML serialized mode only and said non-JavaBean objects are buffered as long as the update process is running, and when said update process is completed said JavaBean objects and said non-JavaBean objects are exchanged in XML serialized mode.

7. The method of claim 4, wherein during said update process said JavaBeans objects are exchanged in a XML serialized mode only and said non-JavaBean objects are buffered as long as the update process is running, and when said update process is completed said JavaBean objects and said non-JavaBean objects are exchanged in XML binary serialized mode.

8. The method of claim 2, wherein during and after said update process said JavaBean objects are exchanged in a XML serialized mode and said non-JavaBean objects are exchanged in a binary mode, if the update includes JavaBean classes only.

9. The method of claim 4, wherein during and after said update process said JavaBean objects are exchanged in a XML serialized mode.

10. The method of claim 9, wherein said non-JavaBean objects are exchanged in a binary mode, if the update includes JavaBean classes only.

11. The method of claim 1, wherein said multiple computers comprise a plurality of nodes.

12. An system for automatically updating Java libraries in a distributed application environment while maintaining its high availability, wherein said distributed application environment comprising multiple computer systems connected with each other via a network, wherein application components are distributed over said multiple computer for exchanging objects in a serialized mode with each other, wherein each of said application component is running in a Java Runtime environment, wherein said Java Runtime environment provides Java libraries being used by said application component at runtime, wherein said system having a link to means for updating said Java Libraries, wherein said system is characterized by
a XML and a binary serialization API provided to each application component running on said system, and
a link to a switching component for switching from XML to binary serialization or vice versa according based on input from said application component, and/or from an user input device.

13. The system of claim 12, wherein said switching component is part of said application component.

14. The system of claim 13, wherein said switching component having a further input indicating the type library classes to be updated.

15. The system of claim 14, further comprises a buffer for buffering non-JavaBean objects.

16. The system of claim 12, wherein said switching component is a central switching component for the entire distributed application environment.

17. The system of claim 12, wherein each of said multiple computer systems each comprises at least one node.

18. The system of claim 12, wherein each of said multiple computer systems each comprises multiple nodes.

19. A computer program product comprising computer executable instructions for performing a method for automatically updating Java libraries in a distributed application environment while maintaining its high availability, wherein said distributed application environment comprising multiple computers connected with each other via a network, wherein application components are distributed over said multiple computer having one or more nodes for exchanging objects in a serialized mode with each other, wherein each of said application component is running in a Java Runtime environment, wherein said Java Runtime environment provides Java libraries being used by said application component at runtime.

20. The computer program product of claim 19, wherein said method further comprises the steps of:
stopping at least a single node within said distributed application environment,
updating the Java libraries of said node, and
re-starting said updated node while all remaining nodes of said distributed application environment are operational and continuously exchanging at least XML serialized objects with each others, and
successively repeating for each node of said distributed application environment said aforementioned steps.
